(19) United States
(12) Patent Application Publication
(10) Pub. No.: US 2019/0324447 A1
(43) Pub. Date: Oct. 24, 2019

(54) Intuitive Controller Device for UAV

(71) Applicant: Kevin Michael Ryan, Whitehouse Station, NJ (US)

(72) Inventor: Kevin Michael Ryan, Whitehouse Station, NJ (US)

(21) Appl. No.: 15/961,736

(22) Filed: Apr. 24, 2018

(51) Int. Cl. G05D 1/00; B64C 39/02; G05D 1/10; G05G 1/04

(52) U.S. Cl. CPC G05D 1/0016; B64C 39/024; B64C 2201/146; G05G 1/04; G05D 1/101

(57) ABSTRACT

This device system is intended for improved manual control of Unmanned Vehicles.

In one embodiment, the device has a pistol grip controller form factor and is setup for single handed operation, outputting full proportional UAV control including pitch, roll, yaw & climb rate. This single handed controller, leaves the operator's other hand free for camera control or other tasks.

The controller design is also more intuitive for the operator to use than a traditional control sticks or virtual scroll type controls. This is essentially accomplished by the hand held controller using its own Euler Angles orientation, Heading & HAGL sensors to directly control the Drone's forward-lateral velocity rate, heading & climb rate (respectively). In effect, by changing the controller's orientation and position in space, translates to drone control.

### BACKGROUND OF THE INVENTION

Unmanned Ground & Air Vehicles (UVs) Operator control systems often have non intuitive controls for manual UV direction and velocity control. Specifically, in many of these systems have Operator Controller that incorporates control sticks, control knobs or similar virtual digital controls in order to control a UV orientation and flight path. These controls are non intuitive for many novice drone operator's because the control sticks and knobs do not correspond well to the actual orientation and flight path of the UV.

The need for manual UV control is significant because the use of unmanned ground and air drones are increasing in many segments of the Military, Government, Commercial and general consumer markets, in which the drone operator may have minimal experience.

Partial solutions to make UV control more intuitive have been attempted in prior art such as drone operator's Controller that incorporate tilt control (as do many smartphone or tablet based drone controllers). The tilt control typically corresponds to the UV's X & Y direction. However these Operator Controllers do not incorporate heading control in the same manner. Heading control is often accomplished by virtual scrollbar or dial, that the drone operator moves with the thumb or finger, which is not intuitive. Additionally, these existing systems often incorporate altitude control in the form of a virtual scrollbar.

Other partial solutions have been made with prior art such as a motion synchronization mechanism, (such as the Flying Head, Unmanned aerial vehicle) that translates the Operator's position (location movement in X, Y & Z axis) as proportional to control the UV's location movement in the same coordinate system. However this type of control solution is not ideal for many applications because the Operator has to move to different locations, for the UV to move to different locations.

Other partial solutions to some of the control issues have been addressed in prior art such as to use more advanced autonomous flight control systems. However autonomous UV control solutions are sometimes less desirable then having a more direct “human in the loop”, full manual control, for reasons of avoiding moving objects and hazards in real time.

### BRIEF SUMMARY OF THE INVENTION

The invention described herein is for an System for Improved Manual Control of Unmanned Vehicles (UVs).

In a first embodiment, the Operator Controller is designed for full manual control of an Unmanned Aerial Vehicle (UV) flight path in X, Y, Z Heading Velocity (Euler Angles velocity vector) & a, b, c Orientation, without the use of less intuitive control sticks or virtual scroll type controls. The Operator Controller is designed to be held by the Drone Operator, for single handed operation, leaving the other hand free for camera control or other tasks.

The Drone Operator may operate the Operator Controller by tilting (orienting) the Operator Controller in an pitch & roll. The magnitude of the pitch & roll translates to the UV velocity in Forward (X Axis) & Lateral (Y Axis), respectively.

For UV Z Axis (altitude) control, the Drone Operator can raise or lower the Operator Controller from a neutral Height Above Ground Level (HAGL). This is termed the delta HAGL. The delta HAGL is used to control the vertical velocity (Z Axis) of the UV. As an example, if the Operator Controller neutral HAGL is 36 in and the Drone Operator raises the Operator Controller to 38 in, the delta HAGL is positive. In this case, the controller will command a positive drone climb rate. Similarly, if the delta HAGL is negative, the controller will command a negative drone climb rate. This climb rate command is proportional to the magnitude of the delta HAGL.

The Drone Operator also operates the Operator Controller by rotating the Operator Controller (changing the compass course heading of the Operator Controller). This Operator Controller course heading is then used to close loop control the UV flight path heading to match the Operator Controller compass course heading.

In effect, the Operator Controller has the ability of full manual control the UV flight path in X, Y, Z Axis & Heading, with a single hand, without the use of less intuitive control sticks or virtual scroll type controls.

In a second embodiment, the Operator Controller be configured with an additional Velocity Proportional Trigger (that is integrated with the Operator Controller, similar to prior art Radio Controlled Car Pistol Grip controllers). The Operator Controller may be programmed to function the same as described in the first embodiment (control mode one), when the Trigger is in the neutral position (zero delta displacement position).

When the Drone Operator manipulates the throttle trigger (displace the trigger away from neutral position), then the Operator Controller switches to a secondary control mode in which the trigger delta from neutral position, controls the speed of the UV proportional to the trigger delta displacement. The UV flight path direction (Euler Angles flight path), is also changed to be controlled parallel to the direction that the Operator Controller is pointed (the UV Flight path will be controlled to parallel Euler Angles in relation to a Operator Controller, in the coordinate system).

The Operator Controller may also be programmed to proportionally transition (by interpolation) between the two operating modes from embodiments one and two, based on percent delta displacement of the velocity trigger.

In a third embodiment, the Operator Controller can be used for controlling a unmanned (or manned) Surface Vehicles. In this embodiment, the Operator Controller can be used in the same manner as in the first & second embodiments, for control of the surface vehicle in X (Forward), Y (Lateral) axis & Heading. The lateral axis may be optional based on the vehicle's lateral movement capability.

In a fourth embodiment, the UV may be programmed to function same as the first, second & third embodiments except that the UV yaw rate is proportional controlled corresponding to the Operator Controller absolute yaw orientation.

The Operator Controller functions primarily by reading orientation sensors (Euler Angles), Height Above Ground Level (HAGL) sensor and Velocity Trigger sensor. The Operator Controller then transmits that data to the UV. The UV is then programmed to continuously take that data and control the Euler Angles flight path and UV velocity, as described herein. For accomplishing this, the UV Controller may use a typical closed feedback control loop to orient the UV Euler Angles velocity vector in at least one axis (such as UV's magnetic heading), to match the Operator Controller's Euler Angles orientation in at least one axis (such as the Operator Controller's magnetic heading).

If the UV incorporates an altitude sensor, the UV may be programmed with closed loop feedback altitude control, corresponding to the Operator Controller delta HAGL.

The Operator Controller may incorporate non contact sensor or sensors to be used for the UV Controller Velocity Proportional Trigger such as an Ultrasonic Ranging Sensor, IR Ranging Sensor or Digital Camera to determine Operator Controller Distance From the Operators body (DFOB). The magnitude of change in DFOB sensor data from the neutral point, may be used as manual control to the UV (such as open loop UV Velocity Control).

A First Person View (FPV) monitor may also be attached or integrated with the Operator Controller.

### EXEMPLARY EMBODIMENTS OF INVENTION

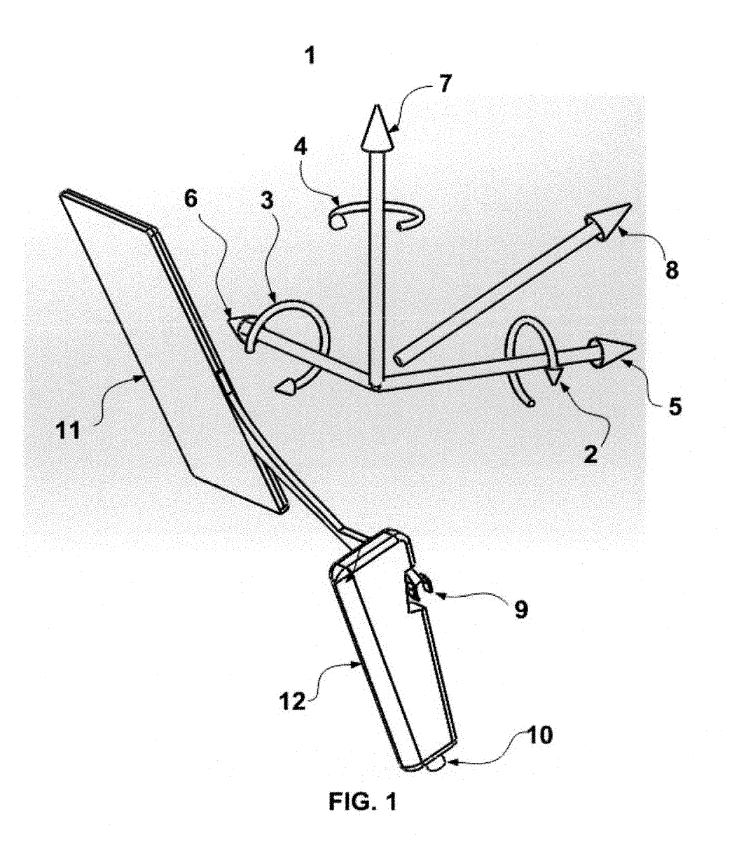

FIG. 1 is a perspective view showing the Operator Controller according to one embodiment of the present invention. This figure shows the Operator Controller orientation (superimposed Euler vector) in relation to the earth.

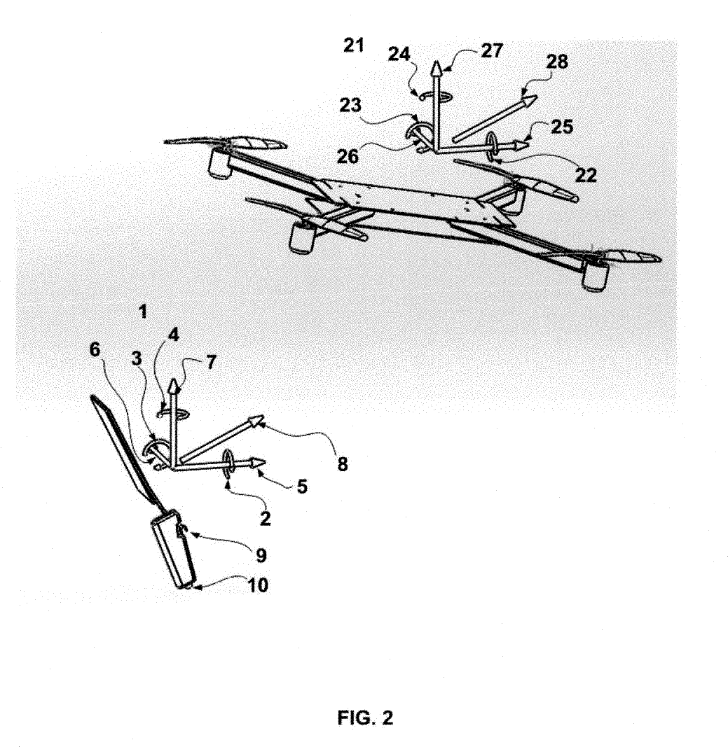

FIG. 2 is a perspective view of the Operator Controller and a Unmanned Vehicle UV according to one embodiment of the present invention. This figure shows the Operator Controller resultant Euler vector and the UV Velocity Vector. The relationship between the Operator Controller Orientation, Trigger displacement, HAGL and the UV Heading and Velocity are as described herein.

### DETAILED DESCRIPTION OF THE INVENTION

While the present invention is susceptible of embodiment in various forms, there is shown in the drawings a presently preferred embodiment that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Invention”) relates to a requirement of the United States Patent Office, and should not be found to limit the subject matter disclosed herein.

In some instances, structures and components that are well known to those skilled in the subject art, are shown in block form or diagram form in order to avoid obscuring the concepts of the subject technology. Like or identical components are labeled with identical element numbers for ease of understanding.

FIG. 1, is a perspective view of the Operator Controller 1, according to one embodiment of the present invention is shown. The Operator Controller Handle 12, can be held by the Drone Operator in order to point or orient the Operator Controller in Pitch 3, Roll 2 & Yaw 4, as shown in vector arrow 8, in relation to the earth coordinate system shown by arrows 6, 5 & 7. The Operator Controller determines it's orientation by using an Absolute Orientation IMU (as common with prior art, not shown). The Drone Operator ran raise or lower the Operator Controller in which changes the Operator Controller delta HAGL. This distance is sensed by HAGL Sensor 10, (such as an Ultrasonic Ranging Sensor, IR Ranging Sensor, Digital Camera or Cameras (Binocular vision) or Barometric Altimeter or a combination of these sensors). The UV Controller has a Velocity Proportional Trigger Sensor 9, (such as a trigger lever attached to a potentiometer) which is an additional Operator input for the UV for determining magnitude of the UV Velocity as shown as length of arrow 8, as described herein. The Velocity Proportional Trigger may alternatively be of non contact sensor type (such as an Ultrasonic Ranging Sensor, IR Ranging Sensor, Digital Camera or Cameras (Binocular vision) (sensor not shown). The Proportional Trigger non-contact sensor may be positioned to sense the distance between the sensor and the Drone Operator (such as head or body). The magnitude of change in the sensor data from the neutral point, may be used as manual control to the UV (such as open loop UV Velocity Control).

The Operator Controller also has a transmitter (not shown) which is used for sending controller sensor data and or direct control commands to a UV as described herein. The UV Controller may also incorporate a camera display 11 for UV first person view (FPV) from the UV. This camera display may also contain some or all of the sensors and components described herein.

FIG. 2, is a perspective view of the Operator Controller 1, with an Unmanned Vehicle (UV) 21 in flight. The Operator Controller numbered items are the same as described for FIG. 1.

The UV has a receiver (not shown), for receiving data from the Operator Controller. The UV also has a Absolute Orientation IMU (not shown) such that at least one axis (such as heading) of the UV flight path Velocity Vector 28, may be close loop controlled to maintain a parallel or proportional relation to the controller orientation, in the same Coordinate System shown by arrows 23, 22, 24, 26, 25 & 27, as the Operator Controller coordinate system. Note that the UV may also have other sensors (such as HAGL sensors, and speed sensors) in order to aid flight path control (as common with prior art, not shown).

1. An Unmanned Vehicle (UV) System comprising;
a. an orientation sensor integrated as part of an Operator controller;
b. a velocity command throttle sensor integrated as part of an Operator controller;
c. a transmitter integrated as part of an Operator controller;

2. The Unmanned Vehicle (UV) System of claim 1, in which an Height Above Ground Level sensor is integrated as part of an Operator controller.

3. The Unmanned Vehicle (UV) System of claim 1, in which an orientation sensor is integrated as part of an UV and a control algorithm that calculates the control commands necessary to orient a UV velocity direction in relation to the Operator controller orientation, is integrated with the UV.

4. The UV Controller of claim 1, in which the a velocity command throttle sensor is of trigger type.

5. The UV Controller of claim 1, in which the velocity command throttle sensor is of non-contact type.

6. The UV Controller of claim 1, in which all Operator controller components are integrated with a smart phone.

7. The UV Controller of claim 1, in which all components are integrated with a smart phone except for a velocity command throttle sensor and Height Above Ground Level Sensor.

8. The UV Controller of claim 5, in which a velocity command throttle sensor transmits to the smart phone by a cable.
